(19) United States
(12) Patent Application Publication
(10) Pub. No.: US 2017/0086561 A1
(43) Pub. Date: Mar. 30, 2017

(54) ADJUSTABLE SPRAY HEAD

(71) Applicant: Zong Jing Investment, Inc., Taipei City (TW)

(72) Inventors: John Chen, Taipei City (TW); Chih-Kun Fan, Taipei City (TW)

(21) Appl. No.: 15/171,006

(22) Filed: Jun. 2, 2016

(30) Foreign Application Priority Data
Sep. 25, 2015 (TW) 104215619

(51) Int. Cl. A45D 34/04; B05B 1/30; B05B 7/04; B05B 7/12; A45D 40/26; A45D 44/00

(52) U.S. Cl. CPC A45D 34/04; A45D 40/26; A45D 44/005; B05B 7/0416; B05B 7/12; B05B 1/3013

(57) ABSTRACT

An adjustable spray head includes a coaxial spray head and an adjusting device. The coaxial spray head includes an outer tube, an inner tube, a needle valve, a gas inlet, and a material inlet. The inner tube is coaxially positioned in the outer tube. One end of the outer tube has an outer exit. The needle valve is coaxially positioned in the inner tube. One end of the inner tube has an inner exit. The top end of the needle valve can be inserted into the inner exit. The adjusting device includes a clamping member, a transmission gear, and a driving motor. The clamping member includes a clamping portion and a teeth bar. The clamping portion clamps the needle valve. The teeth bar is engaged with the transmission gear. The driving motor drives the transmission gear to rotate to drive the clamping member to move linearly.

### CROSS-REFERENCES TO RELATED APPLICATIONS

This non-provisional application claims priority under 35 U.S.C. §119(a) on Patent Application No. 104215619 filed in Taiwan, R.O.C. on 2015 Sep. 25, the entire contents of which are hereby incorporated by reference.

### BACKGROUND

Technical Field

The instant disclosure relates to a spray head, in particular, to an adjustable spray head.

Related Art

Nowadays, people pay more attention to their life qualities. When a person is going to work, hangout, or attend a meeting, he or she not only cares about the dress, but also his or her facial look. Consequently, numerous cosmetics for customers have appeared. Nevertheless, to apply a proper facial makeup or an eye makeup, the user must repeatedly practice the makeup skills. Furthermore, drawing various eyebrow shapes, eye contours, eye lines, and eye shadows, etc., requires the purchase of many kinds of cosmetics and makeup tools. However, the difference in proficiency in the makeup technique and the wide range of cosmetics usually results in a difference between the effect of the makeup and the effect expected by the user.

Accordingly, automatic makeup machines are gradually developed; an automatic makeup machine can put the user-selected makeup on the user by the control of the program of the automatic makeup machine, so that the user can have a makeup with expected effect on his or her face. One of the automatic makeup machines applies the makeup materials onto the user's face by spray heads. A conventional spray head comprises a gas feeding tube, a material feeding tube, and an ejecting opening. Motive gas and makeup material are respectively guided into the spray head by the gas feeding tube and the material feeding tube, and ejected by the ejecting opening. In use of the spray head, the ejecting opening cannot be controlled to open or to close, or the opening size of the ejecting opening cannot be adjusted. As a result, the timing, the color, or the concentration of the ejected makeup material cannot be controlled.

### SUMMARY

In view of these, in one embodiment, an adjustable spray head is provided. The adjustable spray head comprises a coaxial spray head and an adjusting device. The coaxial spray head comprises an outer tube, an inner tube, a needle valve, a gas inlet, and a material inlet. The outer tube is greater than the inner tube. The inner tube is coaxially positioned in the outer tube. A gas channel is formed between the inner tube and the outer tube. One end of the outer tube has an outer exit. The gas channel is communicated between the outer exit and the gas inlet. The inner tube is greater than the needle valve. The needle valve is coaxially positioned in the inner tube. A liquid channel is formed between the inner tube and the needle valve. One end of the inner tube has an inner exit. The inner exit coaxially corresponds to the outer exit. The liquid channel is communicated between the inner exit and the material inlet. The needle valve comprises a top end. The needle valve is movable in the inner tube along the axial direction of the inner tube to allow the top end to be inserted into the inner exit. The adjusting device comprises a clamping member, a transmission gear, and a driving motor. The clamping member comprises a clamping portion and a teeth bar. The clamping portion clamps the needle valve. The teeth bar is engaged with the transmission gear. The driving motor drives the transmission gear to rotate to drive the clamping member to move linearly.

As above, in the adjustable spray head according to embodiments of the instant disclosure, the coaxial alignment of the inner tube and the outer tube allows the motive gas and the makeup material in a material case can be respectively guided into the gas channel and the liquid channel. In addition, the makeup material in the inner tube would mix with the motive gas at a portion close to the outer exit and further ejected out of the outer exit. Moreover, the adjusting device can control the needle valve to move in the inner tube along the axial direction of the inner tube, so that the opening or closing of the inner exit can be controlled, or the opening size of the inner exit can be adjusted. Hence, the timing for material ejection and the concentration of the ejected material can be controlled accurately.

In one embodiment, the inner tube may comprise a cone tapered segment, and the inner exit is located at an end portion of the cone tapered segment. In other words, the diameter of the inner exit is less than the diameter of the inner tube. Alternatively, the inner tube may be a cylinder tube.

In one embodiment, the needle valve may comprise a cone shaped needle, and the top end is located at an end portion of the cone shaped needle. In other words, the top end is the sharp end of the cone shaped needle. Alternatively, the needle valve may be a cylinder tube.

In one embodiment, the adjustable spray head comprises an upper fixing mount and a lower fixing mount. The coaxial spray head is fixed between the upper fixing mount and the lower fixing mount. The driving motor is fixed connected to the lower fixing mount. Alternatively, the driving motor may be fixed connected to the upper fixing mount.

In one embodiment, the adjusting device comprises a packing screw inserted into the clamping member from one end thereof and abutted against the needle valve. Hence, the positioning of the needle valve can be further improved, and the needle valve would not be moved freely relative to the clamping member.

In one embodiment, the diameter of the inner exit may equal to or less than the diameter of the outer exit. Therefore, the liquid flowing out of the inner exit would not be blocked by the outer exit and left in the outer tube.

In one embodiment, the top end of the needle valve may be inserted into the outer exit. As a result, when the needle valve is moved along the axial direction of the inner tube, the opening size of the outer exit can be adjusted at the same time, so that the amount of the material ejected out of the outer exit can be adjusted.

In one embodiment, the adjustable spray head may further comprise a gear assembly connected between the driving motor and the transmission gear. The driving motor drives the gear assembly to drive the transmission gear to rotate. Alternatively, the driving motor may directly drive the transmission gear to rotate without the aids of other gears.

In one embodiment, the gear assembly may comprise a shaft, a passive bevel gear, and an active bevel gear. The transmission gear is coaxially assembled at one of two ends of the shaft, the passive bevel gear is coaxially assembled at the other end of the shaft, and the active bevel gear is drivably connected to the driving motor and engaged with the passive bevel gear.

In one embodiment, the adjustable spray head further comprises an outer housing enclosing the outer exit of the outer tube. The outer housing comprises a passage communicating with the outer exit. Accordingly, when the needle valve is moved along the axial direction of the inner tube, the needle valve would not protrude from the outer exit to hurt someone or to be damaged by someone or something. Furthermore, the liquid ejecting out of the outer exit would not spread, so that the material ejected out of the outer exit can be focused.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of an adjustable spray head according an exemplary embodiment of the instant disclosure;

FIG. 2 illustrates an exploded view of the adjustable spray head;

FIG. 3 illustrates a sectional view (1) of the adjustable spray head;

FIG. 4 illustrates a partial enlarged view of FIG. 3;

FIG. 5 illustrates a sectional view (2) of the adjustable spray head;

FIG. 6 illustrates a partial enlarged view of FIG. 5; and

FIG. 7 illustrates a perspective sectional view of an adjustable spray head according to another exemplary embodiment of the instant disclosure.

### DETAILED DESCRIPTION

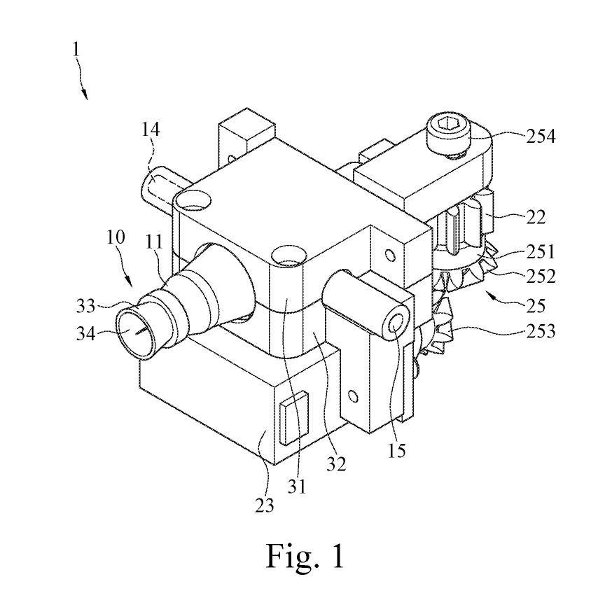

Please refer to FIGS. 1 to 3, respectively illustrating a perspective view, an exploded view, and a sectional view (1) of an adjustable spray head 1 according to an exemplary embodiment of the instant disclosure. In this embodiment, the adjustable spray head 1 comprises a coaxial spray head 10 and an adjusting device 20.

In this embodiment, the coaxial spray head 10 comprises an outer tube 11, an inner tube 12, a needle valve 13, a gas inlet 14, and a material inlet 15. The outer tube 11 and the inner tube 12 are approximately round tubular shaped, and the diameter of the outer tube 11 is greater than the diameter of the inner tube 12. The inner tube 12 is coaxially positioned in the outer tube 11. In other words, the coaxial spray head 10 has dual tubes. In this embodiment, a positioning mount 18 is further assembled in the coaxial spray head 10. The positioning mount 18 may be assembled in the coaxial spray head 10 by gluing, buckling, threading, or other means. The positioning mount 18 has a central groove 181. One end of the inner tube 12 is closely mated or glued in the central groove 181 and positioned by the central groove 181, so that a gas channel 16 is formed between the inner tube 12 and the outer tube 11. In other words, the gas channel 16 surrounds the inner tube 12. Alternatively, in some embodiments, the central groove 181 may have a male thread (or a female thread), and the outer surface of the inner tube 12 has a female thread (or a male thread), so that the inner tube 12 can be threaded in the central groove 181.

One end of the outer tube 11 has an outer exit 111, and the gas channel 16 is communicated between the outer exit 111 and the gas inlet 14. Hence, the external motive gas can be pumped into the coaxial spray head 10 from the gas inlet 14, pass through the gas channel 16, and be ejected out of the outer exit 111. For example, the gas inlet 14 may be connected to one of two ends of a pipeline, and the other end of the pipeline is connected to a gas supplying device like an air pump or a gas cylinder, so that the motive gas can be pumped into the gas channel 16 via the pipeline.

The needle valve 13 is approximately of cylinder shape, and the diameter of the needle valve 13 is less than the diameter of the inner tube 12. The needle valve 13 is coaxially positioned in the inner tube 12. In this embodiment, the positioning mount 18 further comprises a thru groove 182 communicating with the inner tube 12. The needle valve 13 may be inserted into the inner tube 12 through the thru groove 182, so that the needle valve 13 can be coaxially aligned with the inner tube 12. In addition, the needle valve 13 is loosely mated with the thru groove 182, so that the needle valve 13 can be moved along the axial direction of the inner tube 12, and a liquid channel 17 is formed between the needle valve 13 and the inner tube 12. In other words, the liquid channel 17 surrounds the needle valve 13. Moreover, because the inner tube 12 is coaxially positioned in the outer tube 11, the gas channel 16 is partitioned from the liquid channel 17.

One end of the inner tube 12 has an inner exit 121, and the inner exit 121 coaxially corresponds to the outer exit 111. In other words, the center of the inner exit 121 and the center of the outer exit 111 are aligned at the same straight line. In addition, in this embodiment, the inner exit 121 is spaced from the outer exit 111 by an interval. The liquid channel 17 is communicated between the inner exit 121 and the material inlet 15. Therefore, liquids like the makeup painting can be pumped into the material inlet 15 externally, pass through the liquid channel 17, and be ejected out of the inner exit 121. For example, the material inlet 15 may also be connected to a makeup painting case via a pipeline, so that the makeup painting can be pumped into the liquid channel 17 via the pipeline. In addition, because the inner tube 12 is fixed with (may be closely mated, glued to, or threaded with) the positioning mount 18, the inner tube 12 would not be shaken easily. Moreover, in some embodiments, the inner tube 12 may be integrally formed with the positioning mount 18.

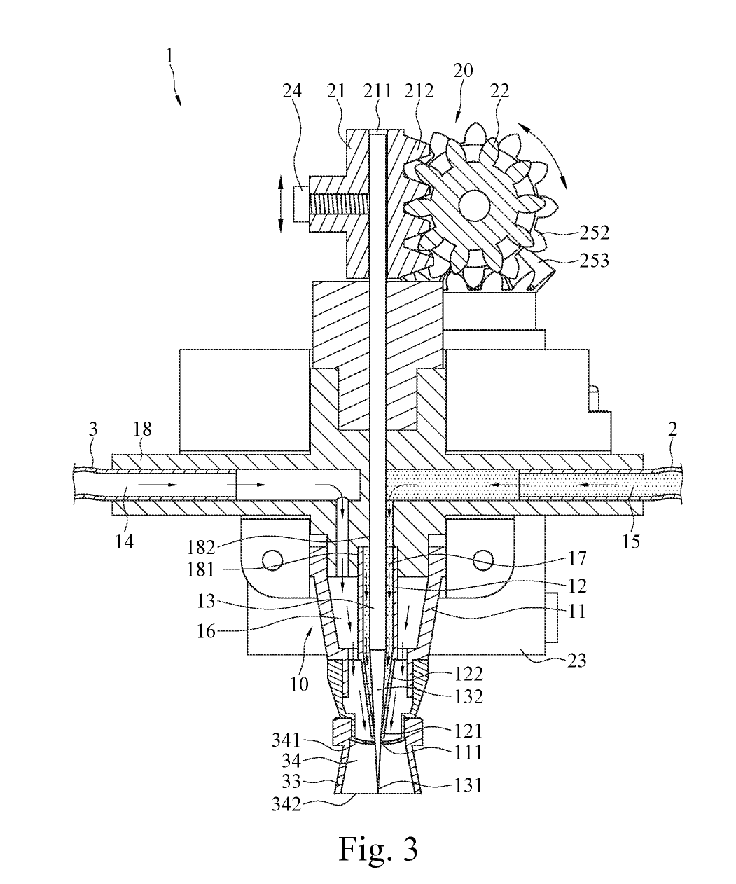

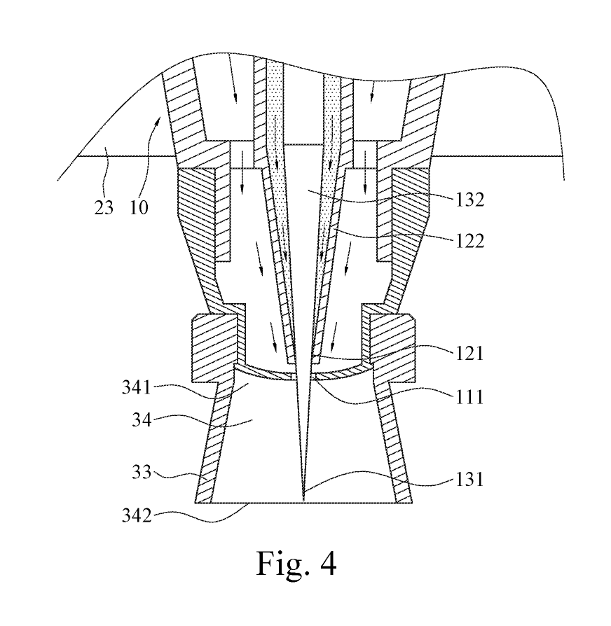

As shown in FIGS. 3 and 4. The needle valve 13 comprises a top end 131 capable of inserting into the inner exit 121. Hence, when the needle valve 13 is moved along the axial direction of the inner tube 12, the opening size of the inner exit 121 can be changed, and the amount of liquid flowing out of the inner exit 121 can be adjusted. In this embodiment, the inner tube 12 comprises a cone-tapered segment 122, and the inner exit 121 is located at an end portion of the cone-tapered segment 122. The needle valve 13 comprises a cone shaped needle 132, and the top end 131 is located at an end portion of the cone shaped needle 132. Therefore, when the needle valve 13 is inserted into the inner exit 121 and moved along the axial direction of the inner tube 12 among (alternatively located at) different positions of the inner tube 12, the cross section of the liquid channel 17 varies according to the position the needle valve 13 located (the cone shaped needle 132 shields the inner exit 121 to different extent). Hence, the opening size of the inner exit 121 is changed, and the amount of liquid flowing out of the inner exit 121 can be adjusted. For example, as shown in FIG. 3, when the top end 131 is moved away from the inner tube 12, the opening size of the inner exit 121 gradually reduces; while when the top end 131 is moved toward the inner tube 12, the opening size of the inner exit 121 gradually increases. In addition, in some embodiments, the needle valve 13 may be a cylinder and may not comprise the cone shaped needle 132, so that the top end 131 is flat. Alternatively, the inner tube 12 may be a cylinder tube and may not comprise the cone-tapered segment 122. Accordingly, when the needle valve 13 is moved along the axial direction of the inner tube 12 with respect to the inner tube 12, the inner exit 121 is opened or closed by the needle valve 13, so that the opening size of the inner exit 121 can be adjusted.

In this embodiment, the adjusting device 20 comprises a clamping member 21, a transmission gear 22, and a driving motor 23. The clamping member 21 comprises a clamping portion 211 and a teeth bar 212. The clamping portion 211 clamps the needle valve 13. The teeth bar 212 is engaged with the transmission gear 22. The driving motor 23 drives the transmission gear 22 to rotate and the clamping member 21, being driven by the transmission gear 22, moves linearly. In this embodiment, the clamping member 21 is a block and located outside of the coaxial spray head 10. The clamping portion 211 is a through slot passing through the clamping member 21. The needle valve 13 is closely mated in the clamping portion 211, so that the clamping member 21 can clamp the needle valve 13. As a result, when the clamping member 21 is moved by the transmission gear 22, the clamping member 21 drives the needle valve 13 to move. The extension direction of the teeth bar 212 is the same as the axial direction of the needle valve 13, so that when the transmission gear 22 is rotated, the transmission gear 22 drives the needle valve 13 to move along the axial direction of the inner tube 12. Please refer to FIG. 4, when the transmission gear 22 is rotated clockwise, the transmission gear 22 drives the clamping member 21 and the needle valve 13 to move away from the outer exit 111 linearly; conversely, when the transmission gear 22 is rotated counterclockwise, the transmission gear 22 drives the clamping member 21 and the needle valve 13 to move toward the outer exit 111 linearly.

Based on the above, the adjustable spray head 1 can be implemented in an automatic makeup machine, as described in the following.

As shown in FIGS. 3 and 4, the material inlet 15 of the coaxial spray head 10 is connected to a makeup material pipe 2 of the automatic makeup machine (not shown), the makeup material pipe 2 may be connected to a makeup painting case, so that the makeup painting can be guided into the liquid channel 17 through the makeup material pipe 2 and the material inlet 15, and moved toward the inner exit 121. It is understood that, the material inlet 15 may guide other liquids like oils or other kinds of paintings or pigments, embodiments are not limited thereto. The gas inlet 14 of the coaxial spray head 10 may be connected to a gas intake pipe 3, so that the motive gas can be guided into the gas channel 16 through the gas intake pipe 3 and the gas inlet 14 and ejected out of the outer exit 111. In this embodiment, the cone-tapered segment 122 of the needle valve 13 blocks the inner exit 121, so that the makeup painting would not flow out of the inner exit 121 and the opening of the inner exit is closed. The adjusting device 20 can control the needle valve 13 to move along the axial direction of the inner tube 12, so that the opening of the inner exit 121 can be opened and the opening size of the inner exit 121 can be changed, and the amount of the makeup painting flowing out of the inner exit 121 can be adjusted, too.

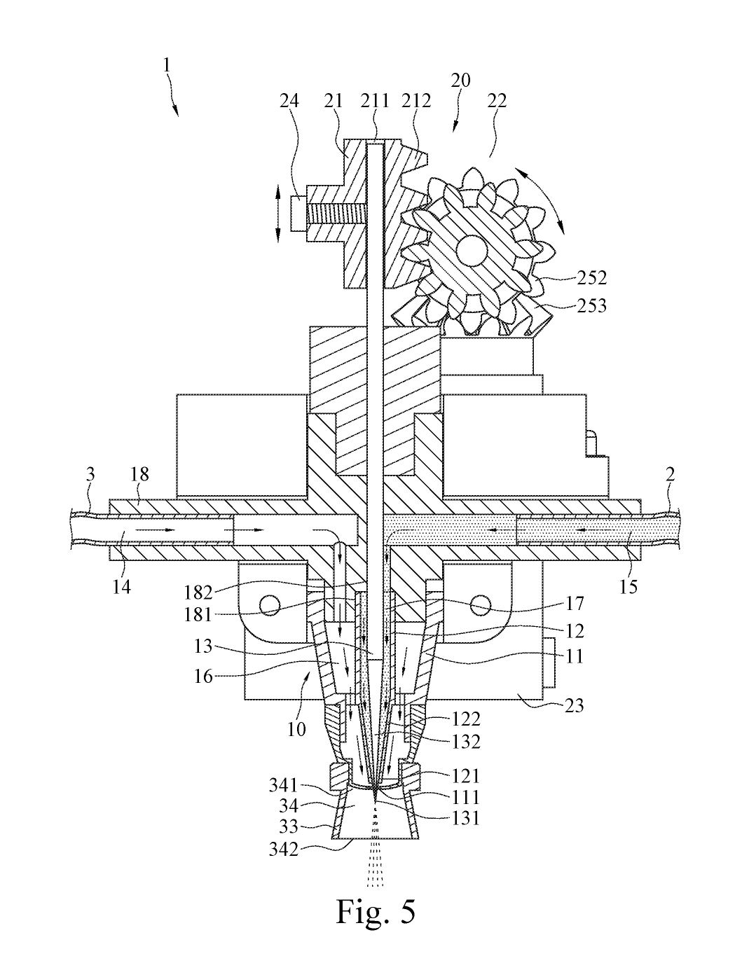

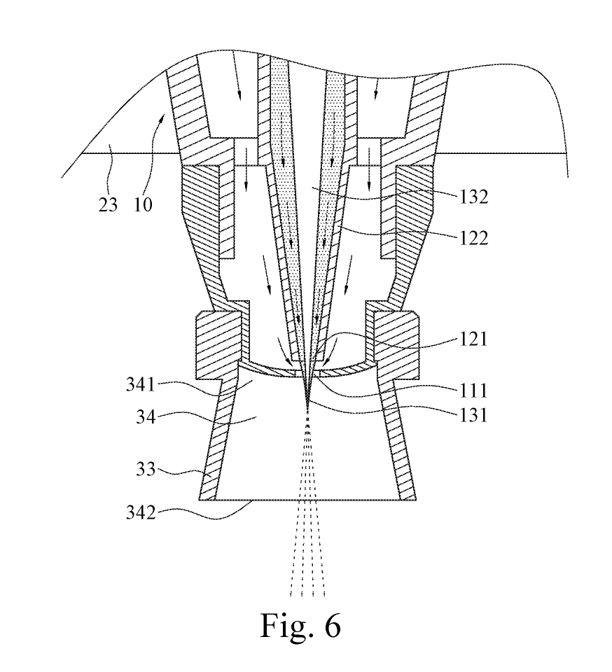

As shown in FIGS. 5 and 6, when the driving motor 23 of the adjusting device 20 drives the transmission gear 22 to rotate (in the figures, the transmission gear 22 rotates clockwise), the teeth bar 212 can be driven, and the clamping member 21 and the needle valve 13 are moved away from the outer exit 111. Therefore, the inner exit 121 is opened and the makeup painting flows out of the inner exit 121, and the makeup painting is further ejected out of the outer exit 111 with the aids of the motive gas guided into the gas channel 16. Hence, the makeup painting can be spread on the user's face. It is understood that, in this embodiment, because of the dual tube configuration (i.e., the inner tube 12 is coaxially positioned in the outer tube 11), the makeup painting does not mix with the motive gas until the makeup painting flows out of the inner exit 121. Hence, the concentration and the color of the makeup painting can be controlled easily. In addition, as in this embodiment, when the adjusting device 20 controls the needle valve 13 to move away from the outer exit 111, the bigger of the opening size of the inner exit 121 is, the greater amount of the makeup painting flowing out of the inner exit 121 is. Conversely, when the driving motor 23 of the adjusting device 20 drives the transmission gear 22 to rotate counterclockwise, the needle valve 13 is moved toward the outer exit 111. Therefore, the size of the portion of the cone-tapered portion 122 for blocking the inner exit 121 increases and the opening size of the inner exit 121 reduces. Hence, the amount of the makeup painting flowing out of the inner exit 121 reduces. Accordingly, the amount and the concentration of the makeup painting flowing out of the inner exit 121 can be controlled accurately.

It is understood that, in addition to adjusting the opening size of the inner exit 121, the needle valve 13 may have other functions. As shown in FIG. 6, the makeup painting has a certain viscosity and would flow along the cone-tapered segment 122 after the inner exit 121 is opened. Therefore, when the motive gas is ejected, the makeup painting would flow along the periphery of the cone-tapered segment 122, move toward the top end 131, and eventually be ejected out of the opening of the inner exit 121 along with the motive gas. Hence, the ejecting position may be focused and the adjustable spray head 1 can perform a better orientation.

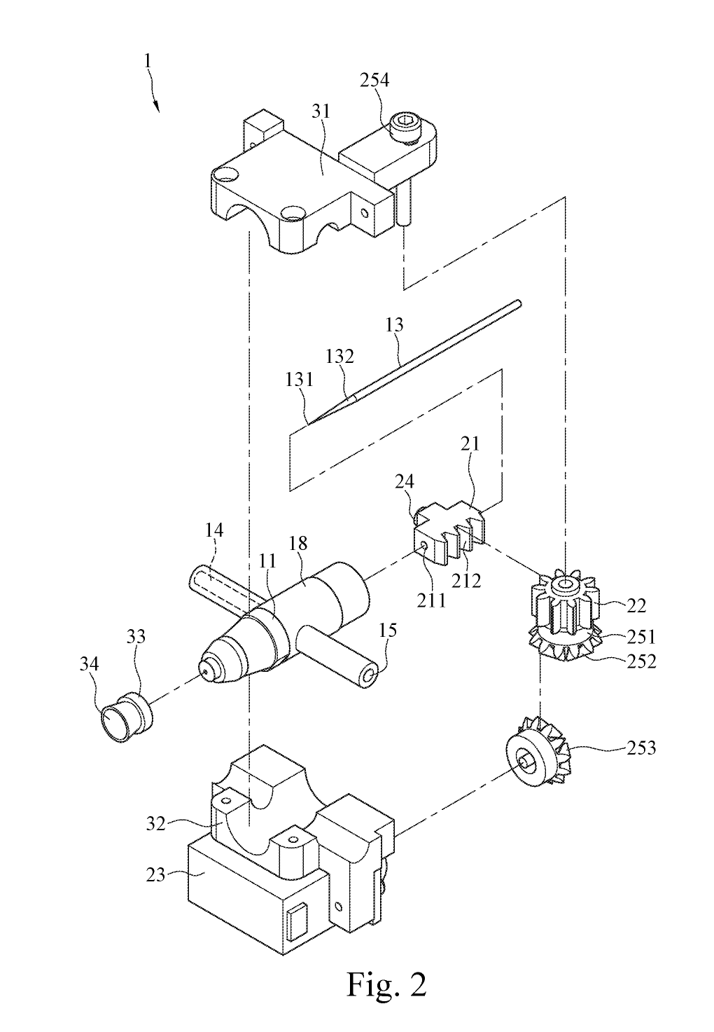

As shown in FIGS. 1 and 2, in this embodiment, the adjustable spray head 1 comprises an upper fixing mount 31 and a lower fixing mount 32. The coaxial spray head 10 is fixed between the upper fixing mount 31 and the lower fixing mount 32. For instance, the upper fixing mount 31 and the lower fixing mount 32 may be locked with each other by screws, and the coaxial spray head 10 is sandwiched between the upper fixing mount 31 and the lower fixing mount 32. The driving motor 23 is fixedly connected to the lower fixing mount 32; e.g., the driving motor 23 may be, but not limited to, locked with or glued with the lower fixing mount 32. In some embodiments, the driving motor 23 may be fixedly connected to the upper fixing mount 31.

The adjusting device 20 may further comprise a gear assembly 25 connected between the driving motor 23 and the transmission gear 22. The driving motor 23 drives the gear assembly 25 to drive the transmission gear 22 to rotate. In this embodiment, the gear assembly 25 comprises a shaft 251, a passive bevel gear 252, and an active bevel gear 253. The transmission gear 22 is coaxially assembled to one of two ends of the shaft 251, and the passive bevel gear 252 is coaxially assembled to the other end of the shaft 251. The shaft 251 is pivoted with the upper fixing mount 31, for example, a pivot 254 is connected to the upper fixing mount 31 and the shaft 251, so that the shaft 251 is positioned and can be rotated relative to the upper fixing mount 31. The active bevel gear 253 may directly connect to a driving shaft of the driving motor 23, so that the active bevel gear 253 can be directly driven by the driving motor 23. In addition, the active bevel gear 253 is engaged with the passive bevel gear 252. Hence, when the active bevel gear 253 is driven by the driving motor 23 to rotate, the active bevel gear 253 drives the passive bevel gear 252 and the transmission gear 22 to rotate and further drives the clamping member 21 and the needle valve 13 to move linearly, but embodiments are not limited thereto. In some embodiments, the driving shaft of the driving motor 23 may be directly connected to the transmission gear 22 without the connection of other gears.

As shown in FIG. 3, in this embodiment, the adjusting device 20 further comprises a packing screw 24 inserted into the clamping member 21 from one side thereof and abutted against the needle valve 13. Therefore, the positioning of the needle valve 13 can be further improved, and the needle valve 13 would not be moved freely with respect to the clamping member 21. The packing screw 24 may be a self tapping screw which can be directly threaded into the clamping member 21 from one side of the clamping member 21. Alternatively, in some embodiments, one side of the clamping member 21 may have a screw hole to allow the packing screw 24 to be threaded therein and abutted against the needle valve 13.

As shown in FIGS. 3 to 6, in this embodiment, the diameter of the inner exit 121 is preferably less than (or may be equal to) the diameter of the outer exit 111. Hence, the liquid flowing out of the inner exit 121 would not be blocked by the outer exit 111 and left in the outer tube 11.

As shown in FIGS. 3 and 5, in this embodiment, the top end 131 of the needle valve 13 may be further inserted into the outer exit 111. Therefore, when the needle valve 13 is moved along the axial direction of the inner tube 12, the opening size of the outer exit 111 can be adjusted at the same time, so that the amount of the material ejected out of the outer exit 111 can be adjusted.

As shown in FIGS. 5 and 6, in this embodiment, the adjustable spray head 1 further comprises an outer housing 33. The outer housing 33 is buckled with an end portion of the coaxial spray head 10 where the outer exit 111 is located at, and the outer housing 33 is enclosing the outer exit 111 of the outer tube 11. The outer housing 33 comprises a passage 34 communicating with the outer exit 111. Accordingly, when the needle valve 13 is moved along the axial direction of the inner tube 12, the needle valve 13 can be protected by the outer housing 33 and would not protrude from the outer exit 111 to hurt someone or to be damaged by someone or something. In addition, the liquid ejecting out of the outer exit 111 would not spread, so that the liquid ejected out of the outer exit 111 can be focused.

In addition, in this embodiment, the passage 34 comprises a shrunk end 341 and an expanded end 342. In other words, the passage 34 is cone shaped. The shrunk end 341 is closer to the outer exit 111 than the expanded end 342, so that the liquid sprayed out of the outer exit 111 can be slightly spread outward, but embodiments are not limited thereto. In some embodiments, the outer housing 33 may be cylinder or inverse cone shaped, according to different requirements.

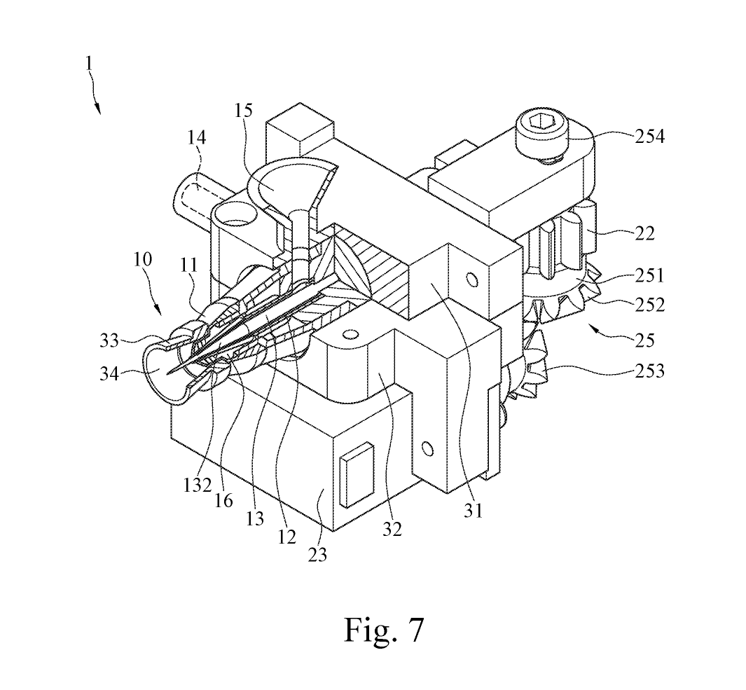

Please refer to FIG. 7, illustrating an adjustable spray head 1 according to another exemplary embodiment of instant disclosure. In the foregoing embodiment, the gas inlet 14 and the material inlet 15 are aligned by a 180 degree configuration; i.e., the motive gas and the makeup material are respectively guided from two opposite ends of the outer tube 11. In the present embodiment, the gas inlet 14 and the material inlet 15 are aligned by a 90 degree configuration. Here, the material inlet 15 is at the top of the outer tube 11, while the gas inlet 14 is at one side of the outer tube 11. Hence, the makeup material is guided into the coaxial spray head 10 from the top of the outer tube 11, while the motive gas is guided into the coaxial spray head 10 from one side of the outer tube 11. In some embodiments, the gas inlet 14 may be at the top of the outer tube 11, and the material inlet 15 is at one side of the outer tube 11. Alternatively, in some embodiments, the gas inlet 14 and the material inlet 15 may be aligned by other configurations (e.g., 20 degree, 30 degree, 45 degree, 60 degree, 80 degree, or other angle configurations), embodiments are not limited thereto.

As above, in the adjustable spray head according to embodiments of the instant disclosure, the coaxial alignment of the inner tube and the outer tube allows the motive gas and the makeup material in a material case can be respectively guided into the gas channel and the liquid channel. In addition, the makeup material in the inner tube would mix with the motive gas at a portion close to the outer exit and further ejected out of the outer exit. Moreover, the adjusting device can control the needle valve to move in the inner tube along the axial direction of the inner tube, so that the opening or closing of the inner exit can be controlled, or the opening size of the inner exit can be adjusted. Hence, the timing for material ejection and the concentration of the ejected material can be controlled accurately.

While the disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An adjustable spray head, comprising:
a coaxial spray head, comprising an outer tube, an inner tube, a needle valve, a gas inlet, and a material inlet, wherein the outer tube is greater than the inner tube, the inner tube is coaxially positioned in the outer tube, a gas channel is formed between the inner tube and the outer tube, one end of the outer tube has an outer exit, the gas channel is communicated between the outer exit and the gas inlet, the inner tube is greater than the needle valve, the needle valve is coaxially positioned in the inner tube, a liquid channel is formed between the inner tube and the needle valve, one end of the inner tube has an inner exit, the inner exit coaxially corresponds to the outer exit, the liquid channel is communicated between the inner exit and the material inlet, the needle valve comprises a top end, the needle valve is movable in the inner tube along the axial direction of the inner tube to allow the top end to be inserted into the inner exit; and
an adjusting device, comprising a clamping member, a transmission gear, and a driving motor, wherein the clamping member comprises a clamping portion and a teeth bar, the clamping portion clamps the needle valve, the teeth bar is engaged with the transmission gear, the driving motor drives the transmission gear to rotate and the transmission gear drives the clamping member to move linearly.

2. The adjustable spray head according to claim 1, wherein the inner tube comprises a cone-tapered segment, the inner exit is located at an end portion of the cone-tapered segment.

3. The adjustable spray head according to claim 1, wherein the needle valve comprises a cone shaped needle, the top end is located at an end portion of the cone shaped needle.

4. The adjustable spray head according to claim 2, wherein the needle valve comprises a cone shaped needle, the top end is located at an end portion of the cone shaped needle.

5. The adjustable spray head according to claim 1, further comprising an upper fixing mount and a lower fixing mount, the coaxial spray head is fixed between the upper fixing mount and the lower fixing mount, and the driving motor is fixedly connected to the lower fixing mount.

6. The adjustable spray head according to claim 1, wherein the adjusting device further comprises a packing screw inserted into the clamping member from one side thereof and abutted against the needle valve.

7. The adjustable spray head according to claim 1, wherein the diameter of the inner exit is equal to or less than the diameter of the outer exit.

8. The adjustable spray head according to claim 1, wherein the top end of the needle is further insertable into the outer exit.

9. The adjustable spray head according to claim 1, further comprising a gear assembly connected between the driving motor and the transmission gear, the driving motor drives the gear assembly to drive the transmission gear to rotate.

10. The adjustable spray head according to claim 9, wherein the gear assembly comprises a shaft, a passive bevel gear, and an active bevel gear, the transmission gear is coaxially assembled to one of two ends of the shaft, the passive bevel gear is coaxially assembled to the other end of the shaft, the active bevel gear is drivably connected to the driving motor and engaged with the passive bevel gear.

11. The adjustable spray head according to claim 1, further comprising an outer housing enclosing the outer exit of the outer tube, wherein the outer housing comprises a passage communicating with the outer exit.

12. The adjustable spray head according to claim 11, wherein the passage comprises a shrunk end and an expanded end, the shrunk end is closer to the outer exit than the expanded end.
